(19) United States
(12) Patent Application Publication
(10) Pub. No.: US 2006/0274280 A1
(43) Pub. Date: Dec. 7, 2006

(54) Heat radiation device capable of resisting light leakage

(76) Inventor: Wen-Hao Liu, Taipei (TW)

Correspondence Address: G. LINK Co., LTD, 3550 Bell Road, MINOOKA, IL, 60447, US

(21) Appl. No.: 11/146,244

(22) Filed: Jun. 7, 2005

(51) Int. Cl. G03B 21/18

(52) U.S. Cl. 353/57

(57) ABSTRACT

A heat radiation device capable of blocking light leakage, which applied to a projection system with at least a light source, includes a fan wheel, a fan frame and a stop part. The fan frame defines a flow passage to receive a hub seat for being attached with the fan wheel. The fan wheel has a plurality of fan blades extending outward from the hub radially with each of the fan blades spacing apart from each other and overlapping to another one of the fan blades next to it. A clearance is kept between the flow passage and the fan wheel. The stop part is disposed at the rim of the fan frame to extend toward the center of the fan frame with a length at least covering the clearance between the flow passage and the fan wheel. Hence, light projecting to the heat dissipation device from the light source is shaded by way of the stop part and the overlapped fan blades to avoid light leakage.

### BACKGROUND OF THE INVENTION

1. Field of the Invention

The present invention is related to a system heat dissipation device capable of resisting light leakage and particularly to a system with a heat dissipation fan and light shading unit applied in a projection system with a light source to perform functions of light shading and heat radiation.

2. Brief Description of the Related Art

Due to technology development progressing tremendously, the projection apparatus has been applied to various fields. Currently, the projection apparatus is divided into two categories, optical projection device and liquid crystal projection device. A light source and a processing device are essential parts for both of the projection devices. The light source emits light beam and the processing device treats and control the light beam based on need so as to obtain best quality projections and contrast ratio.

Accordingly, the light source is the major source of heat generation and how to keep the light source with good heat dissipation and good ventilation under a condition of high power use is getting important. In order to reach the preceding effect of good heat dissipation and good ventilation, a cooling fan has been provided in the vicinity of the light source and a window hole is provided to be located opposite to the cooling fan such that heat from the light source can be discharged via the window hole. However, part of the light beam leaks outward the window hole via the fan blades because each of the fan blades of the cooling fan are arranged to space apart from each other but not overlap to the fan blade next to it respectively. As a result, the quality of projected image is degraded and quality of view is influenced. In order to overcome the preceding deficiency, a plurality of palisade shaped slant shading plates are disposed spaced between the light source and the fan. However, the shading plates make the entire device huge in size and the fabrication cost and the material cost increase significantly. In addition, smoothness of air flow is influenced substantially. Thus, undesirable heat dissipation effect is obtained.

Furthermore, Taiwanese Patent Official Gazette No. 532495 entitled “PROJECTOR CAPABLE OF SHADING LIGHT” includes a casing with a plurality of window holes, a light source disposed in the casing next to the window hole, a fan disposed between the light source and the window hole and a plurality of light shading fins. The fan has a plurality fan blades spacing apart and extending outward from the center thereof and the shading fins are attached to at least one surface of each fan blade respectively and extend toward another fan blade next to it for blocking light beam shooting the window hole from the light source.

Besides, each of the fan blades is disposed on the rotational shaft and extends obliquely around the shaft with a first lateral rim in the vicinity of the light source and a second lateral rim being opposite to the first lateral rim and in the vicinity of the casing. The second lateral rim of each fan blade and the first lateral rim of another fan blade next to it are on a line.

However, the preceding structure has a problem in practice. Because the surface of each fan blade has shading fins extending toward the fan blade next to it, fluid, which passes through spaces between fan blades, is blocked due to the shading fins while the fan induces the fluid to flow. That is, flow paths between the fan blades are affected by the transverse shading fins and the fluid moves along the flow paths becomes turbulence. It leads to produce high decibel noise while the fan is in operation. In addition, number of the fan blades has to be reduced because the shading fins mounted to the fan blades need spaces available for extending transversely such that the flow rate induced by the fan is lowered and it results in undesirable effect of heat dissipation. In addition, the space between the fan blades and the flow passage, i.e., the space confined for receiving the fan, is available for turning of the fan and the flow passage has to be greater than the diametrical area of the fan. In other words, a clearance is between outer end of the respective fan blade and the flow passage because of structural limitation and part of the light beam is able to shine outward via the clearance even if the fan blades is capable of resisting part of the light beam.

### SUMMARY OF THE INVENTION

In order to solve the preceding problems residing in the conventional device, an object of the present invention is to provide a system radiation device capable of resisting light leakage with which a projection system with at least a light source can cooled and light can blocked without more components.

Another object of the present invention is to provide a system radiation device capable of resisting light leakage in which each of the fan blades thereof overlaps another fan blade next to it and the fan frame thereof provides a stop part, which has a extension distance equal to or greater than a clearance between the flow passage and the fan wheel, being disposed along the outer side of the flow passage and extending toward the center of the fan frame to shade light beam shooting the fan thereof.

A further object of the present invention is to provide a system radiation device capable of resisting light leakage in which each of the fan blades thereof overlaps another fan blade next to it and the fan frame thereof has a conical flow passage with the radial space at an end thereof not greater than diametrical area of the fan wheel to avoid light leakage.

A further object of the present invention is to provide a system radiation device capable of resisting light leakage in which a light shading unit is disposed between the hub seat and the inner wall of the fan frame to avoid light leakage.

In order to achieve the preceding objects, the system radiation device capable of resisting light leakage of the present invention, which is applied to a projection system with at least a light source, includes a fan wheel, a fan frame and a stop part. The fan frame defines a flow passage to receive a hub seat for being attached with the fan wheel. The fan wheel has a plurality of fan blades extending outward from the hub radially with each of the fan blades spacing apart from each other and overlapping to another one of the fan blades next to it. A clearance is kept between the flow passage and the fan wheel. The stop part is disposed at the rim of the fan frame to extend toward the center of the fan frame with a length at least covering the clearance between the flow passage and the fan wheel.

The extension distance of the stop part is equal to the clearance between the flow passage and the fan wheel.

Further, the system radiation device capable of resisting light leakage according to the present invention includes a fan wheel and a fan frame. The fan wheel has a hub and a plurality of fan blades extending outward from the hub radially and each of the fan blades spacing apart each other and overlapping to another one of the fan blades next to it. The fan frame with the inner wall thereof being slant defines a conical flow passage for receiving the fan wheel and the flow passage forms a first end and a second end at two lateral sides of the fan frame with a radial volume of the first end being greater than the diametrical area of the fan wheel and the radial volume of the second end being not greater than the diametrical area of the fan wheel.

The flow passage receives a hub seat for being attached with the fan frame.

A plurality of support members are provided between the hub seat and the inner wall of the fan frame,

The support members are arranged to space apart from each other.

Each of the support members overlaps another one of the support members next to it respectively.

Further, the system radiation device capable of resisting light leakage according to the present invention includes a fan wheel, a fan frame and a slight shading unit. The fan wheel has a hub and a plurality of fan blades extending outward from the hub radially. The fan frame with the inner wall thereof defines a flow passage and a hub seat is receive in the flow passage for being attached with the fan wheel. The shading unit is provided between the hub seat and the fan frame.

The light shading unit is provided with a plurality of support plates.

The support plates are arranged to space apart from each other and overlaps another one of the support plates next to it respectively.

The light shading unit is provided with at least a support stick and a plurality of concentric rings connecting with the support stick and the concentric rings are slant with each of the concentric rings spacing apart to each other and overlapping to another one of the concentric rings next to it respectively.

Further, the system radiation device capable of resisting light leakage according to the present invention includes a casing, a light source and a heat dissipation device. The casing is provided with at least a window hole. The light source is disposed in the casing.

The heat dissipation device is disposed between the light source and the window hole and provides a fan wheel with a plurality of fan blades extending outward radially. The light shading unit is disposed in the window hole.

The shading unit is provided with a plurality of support plates.

The support plates overlaps another one of the support plates next to it respectively.

The light shading unit is provided with at least a support stick and a plurality of concentric rings connecting with the support stick and the concentric rings are slant with each of the concentric rings spacing apart to each other and overlapping to another one of the concentric rings next to it respectively.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a sectional view of the first embodiment of a heat dissipation module system capable of resisting light leakage according to the present invention;

FIG. 2 is a top view of the first embodiment of a heat dissipation module system capable of resisting light leakage according to the present invention;

FIG. 3 is a plan view illustrating the first preferred embodiment of a heat radiation module system capable of resisting light leakage according to the present invention being applied to a projection device;

FIG. 4 is a sectional view of the second embodiment of a heat radiation module system capable of resisting light leakage according to the present invention;

FIG. 5 is a top of the second preferred embodiment of a heat radiation module system capable of resisting light leakage according to the present invention;

FIG. 6 is a plan view illustrating the second preferred embodiment of a heat radiation module system capable of resisting light leakage according to the present invention being applied to a projection device;

FIG. 7 is a sectional view of the third embodiment of a heat radiation module system capable of resisting light leakage according to the present invention;

FIG. 7A is an enlarged view of the part of circular dash lines shown in FIG. 7;

FIG. 8 is a top view of the third embodiment of a heat radiation module system capable of resisting light leakage according to the present invention;

FIG. 9 is a plan view illustrating the third preferred embodiment of a heat radiation module system capable of resisting light leakage according to the present invention being applied to a projection device;

FIG. 10 is a sectional view illustrating another configuration of a blocking light unit in the third embodiment of a heat radiation module system capable of resisting light leakage according to the present invention;

FIG. 11 is a top view of another configuration of a blocking light unit in the third embodiment of a heat radiation module system capable of resisting light leakage according to the present invention;

FIG. 12 is a plan view illustrating the blocking light in third preferred embodiment of a heat radiation module system capable of resisting light leakage according to the present invention being applied to a projection device;

FIG. 13 is a perspective view of the fourth embodiment of a heat radiation module system capable of resisting light leakage according to the present invention;

FIG. 14 is a front view of a window hole with light blocking unit in the fourth embodiment of a heat radiation module system capable of resisting light leakage according to the present invention;

FIG. 15 is a perspective view of the fifth embodiment of a heat radiation module system capable of resisting light leakage according to the present invention;

FIG. 16 is a front view of a window hole with light blocking unit in the fifth embodiment of a heat radiation module system capable of resisting light leakage according to the present invention;

FIG. 17 is a perspective view of the sixth embodiment of a heat radiation module system capable of resisting light leakage according to the present invention; and

FIG. 18 is a front view of a window hole with light blocking unit in the sixth embodiment of a heat radiation module system capable of resisting light leakage according to the present invention.

### DETAILED DESCRIPTION OF THE INVENTION

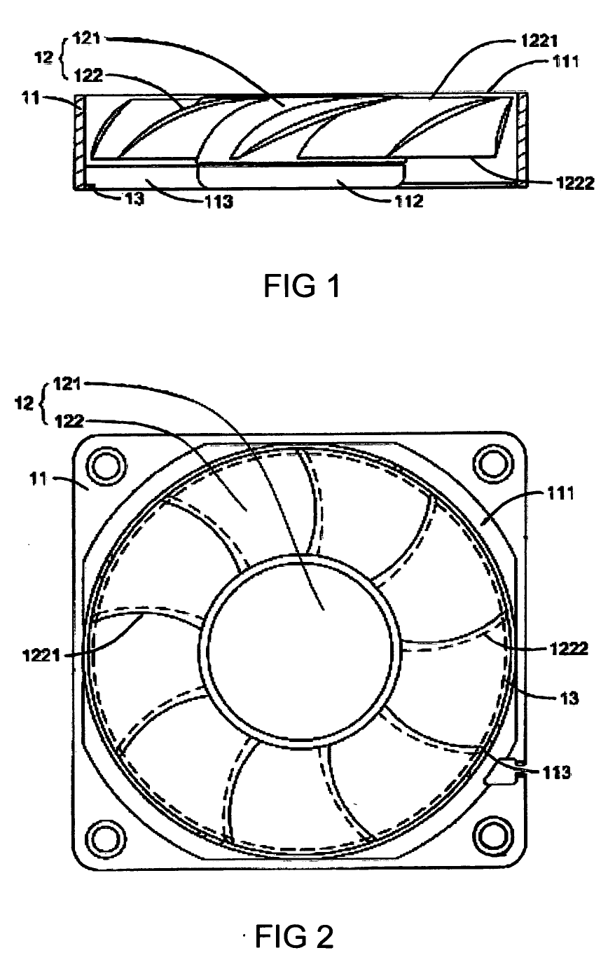

Referring to FIGS. 1 to 3, the first embodiment of a heat radiation module system capable of resisting light leakage according to the present invention includes a fan frame 11, a fan wheel 12 and a stopper 13. The fan frame 11 has a flow passage 111 defined by the inner wall thereof and the flow passage 111 further has a hub seat 112 and a plurality of support members 113 are disposed between and connect with the inner wall of the fan frame 11 and the hub seat 112. The support members 113 are arranged to space from each other. The fan wheel 12 is rotationally attached to the hub seat 112 with a hub 121 and a plurality of radial fan blades 122 extending from the hub 121. Each of the fan blades 122 has a first blade rim 1221 and a second blade rim 1222 opposite to the first blade rim 1221 and the fan blades 122 are arranged to spacing apart from each other with the first fan blade rim 1221 of each of the fan blades 122 covering the second blade rim 1222 of neighboring fan blade next to it. The stopper 13 is disposed on the fan frame 11 to extend toward the center of fan frame 11 along outer side of the flow passage 111 defined by the fan frame 11.

Due to structural limitation, a clearance is between the fan frame 11 and ends of the fan blades 122 and extension distance of the stopper 13 is equal to or exceeding the clearance. That is, the extension distance of the stopper 13 just covers the clearance between the fan frame 11 and the fan wheel 12 or exceeds covering the clearance.

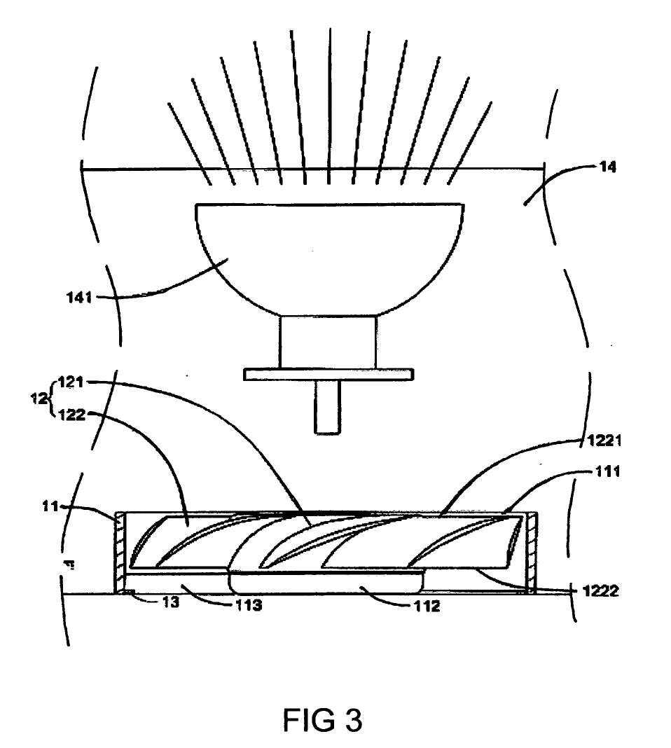

Referring to FIG. 3, the projection device 14 includes a high power light source 141 and the light beam of the light source 141 emits toward all directions in addition to emitting forward. The projection system 14 has a casing (not shown) to prevent the light beam from exposing outward. In order to cool the light source 141, the cooling fan is provided at the air outlet of the projection system 14 such that the hot air from the light source 14 can be discharged while the fan wheel 12 is in operation and the overlapped fan blades 122 and stopper 13 can block the light beam shooting the heat dissipation device and then stop the light beam toward the air outlet. In this way, the light is unable to leak outward without the need of a shading plate used in the conventional device. Further, the deficiency of a shading fin extending from the surface of each of the fan blades transversely provided in the conventional device, which causes greater resistance to the fluid flow path and results in turbulence, can be overcome. It is appreciated that the present invention can provides not only heat dissipation but also light shading.

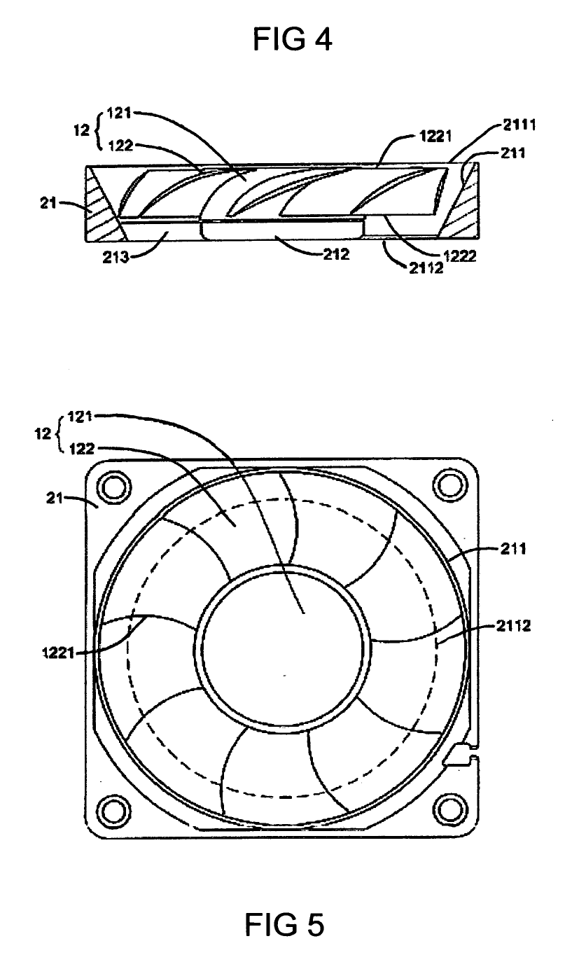

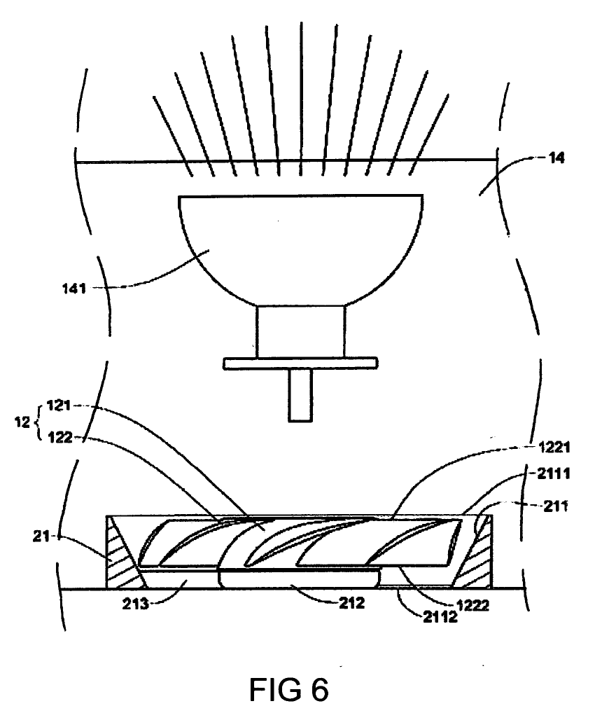

Referring to FIGS. 4, 5 and 6, the second embodiment of the present invention is illustrated. The entire structure and function of the second embodiment are almost the same as the preceding embodiment and it is noted that identical parts are designated as the same reference numbers. The difference of the present embodiment is in that the inner wall of the fan frame 21 is slant and defines a conical flow passage 211 for receiving the fan frame 21. The flow passage 211 has a first end 2111 and a second end 2112 at both lateral sides of fan frame 21 respectively. The radial volume of the first end 2111 is greater than diametrical area of the fan wheel 12 and the radial volume of the second end 2112 is not greater than the diametrical area of the fan wheel 12. The second end 212 has a hub seat 212 for joining with the fan wheel 12 and a plurality of support members 213 are fixedly attached between the fan wheel 12 and the inner wall of the fan frame 21. The support members 213 can be arranged to space apart from each other in radial way or in parallel for avoiding light exposing outward.

Further, each of the support members 213 can be arranged to overlap another one of the support members 213 next to it respectively for reaching the purpose of light shading.

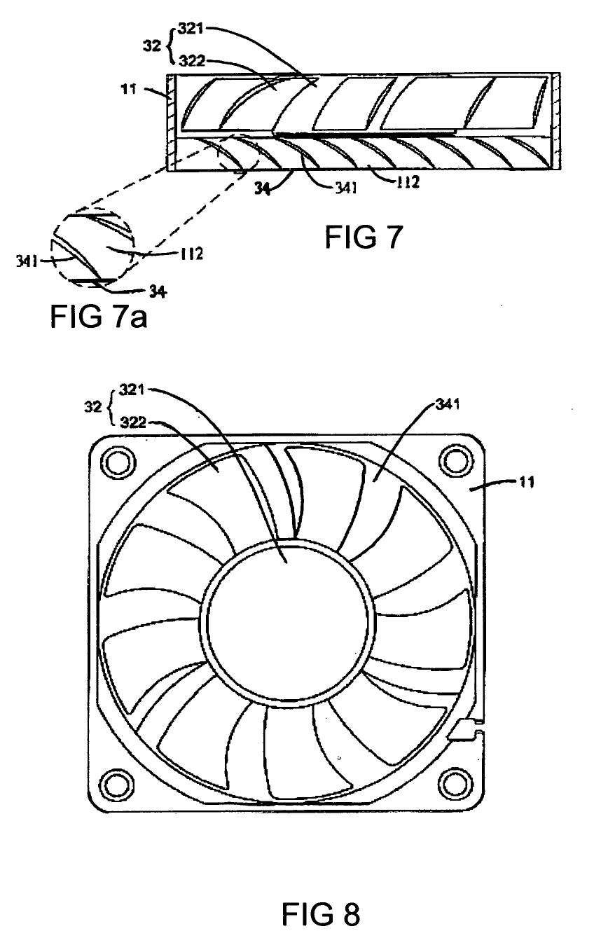

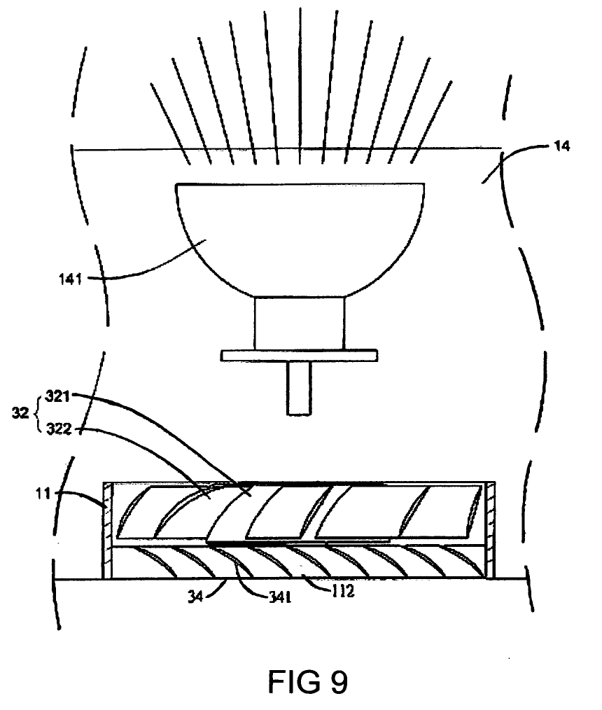

Referring to FIGS. 7, 7A, 8 and 9, the third embodiment of the present invention is illustrated. The entire structure and function of the second embodiment are almost the same as the preceding embodiment and it is noted that identical parts are designated as the same reference numbers. The difference of the present embodiment is in that the fan wheel 32 has hub 321 and a plurality of radial fan blades 322 and a light shading unit 34. The fan blades 322 extend from the hub 321 and the fan blades 322 are arranged to space from each other but without overlapping to each other. The light shading unit 34 is disposed between the hub seat 112 and inner wall of the fan frame 11 can be a plurality of support members 341, which are arranged to space from each other and overlap a support members 341 next to them respectively. The light shading unit 34 can block the light shooting the heat dissipation device so as to prevent from light leakage.

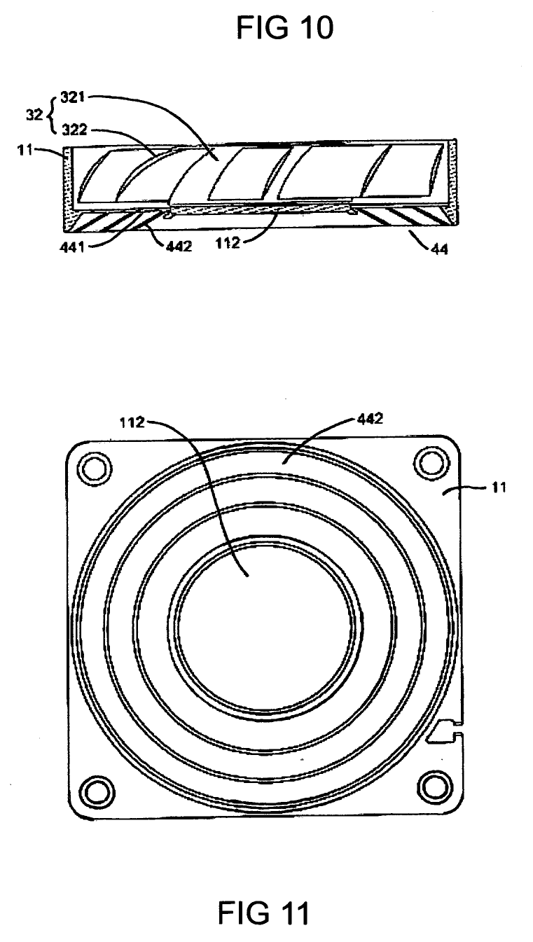

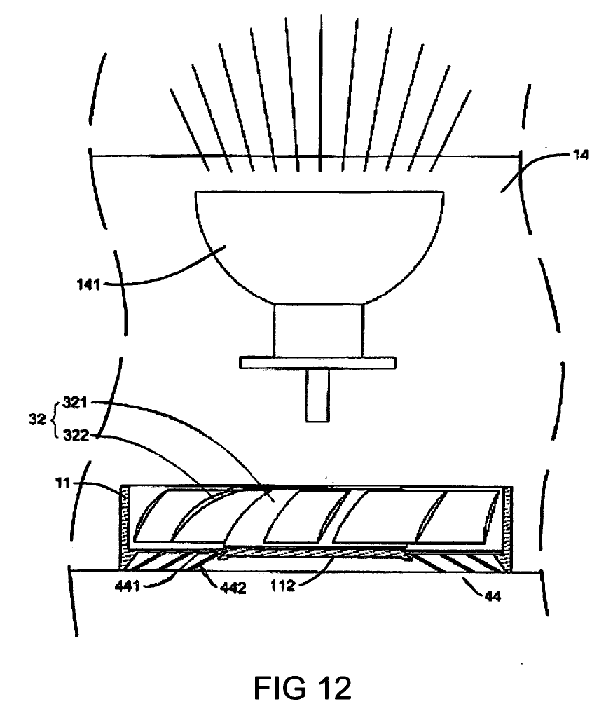

Referring to FIGS. 10. 11 and 12, alternatively, the light shading unit 44 includes at least a support member 441 and a plurality of concentric rings 442. The support member 441 connects with the concentric rings 442 and each of the concentric rings 442 inclines toward the outer side of the fan frame 11 and overlap a concentric ring 442 next to them respectively.

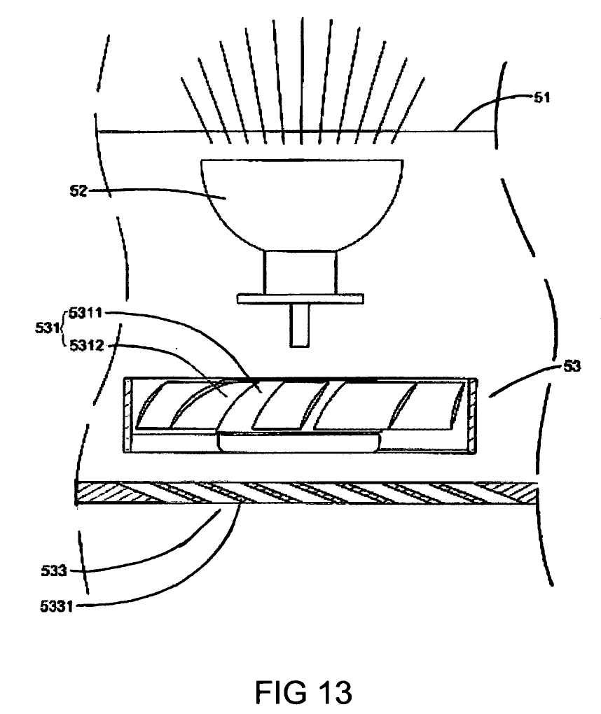

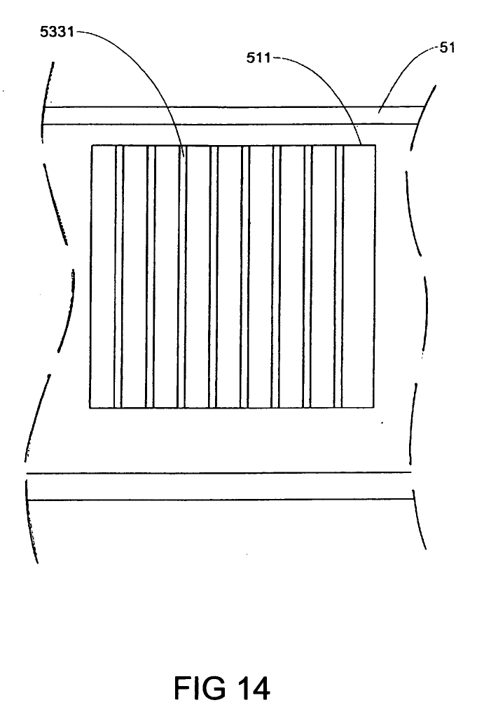

Referring to FIGS. 13 and 14, the fourth embodiment of the present invention is illustrated. It can be seen that a projection system includes a casing 51 with at least a window hole 53 (shown in FIG. 14). The casing 51 further has a light source 52 and a heat dissipation device 53. The light source 52 produces light beam projecting forward and all other directions and the heat dissipation device 53 is disposed between the light source 52 and the window hole 511. The heat dissipation device 53 has a fan wheel 531 with a hub 5311 and a plurality of and a plurality of radial fan blades 5312 extending from the hub 5311 and a light shading device 533. The light shading device 533 is disposed in the window hole 511. The light shading device 533 in the present embodiment icludes a plurality of support plate 5331 and each support plate 5331 spaces apart from another support plate 5331 next to it respectively. That is, each of the support plates 5331 connects with the inner wall of the window hole 511 at both ends thereof respectively and spaces apart and overlaps to another support plate 5331 next to it. The support plates 5331 can be arranged radially or in parallel.

Once the fan wheel 531 of the heat dissipation device 53 is in operation, the hot air created by the light source 52 can be induced to flow toward the window hole 511 and discharged outward so that temperature in the casing 51 can be lowered and the temperature of the projection system can be lowered too. Further, the shading device 533 blocks light to shoot the window hole 511 via the heat dissipation device 53 so that it is capable of preventing the light from leaking outward.

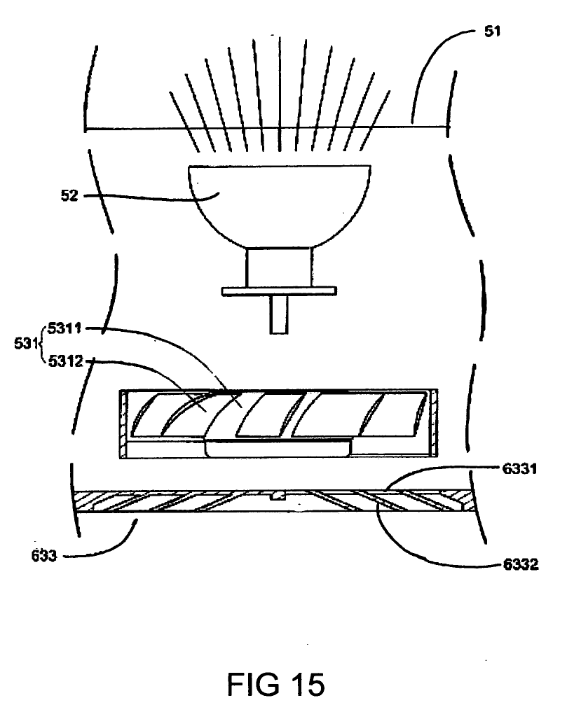

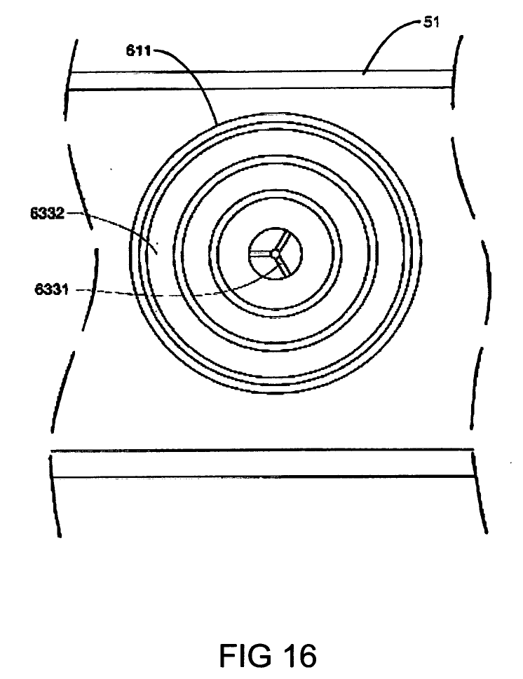

Referring to FIGS. 15 and 16, the fifth embodiment of the present invention is illustrated. The entire structure and function of the second embodiment are almost the same as the preceding embodiment and it is noted that identical parts are designated as the same reference numbers. The difference of the present embodiment is in that the window hole 611 is circular and, alternatively, the light shading unit 633 includes at least a support stick 6331 and a plurality of concentric rings 6332 connecting with the support stick 6331. The concentric rings 6332 are provided with an inclining shape respectively and space apart from each other. Further, each of the concentric rings 6332 overlaps to another one of the concentric rings 6332 next to it for reaching the purpose of light shading as well.

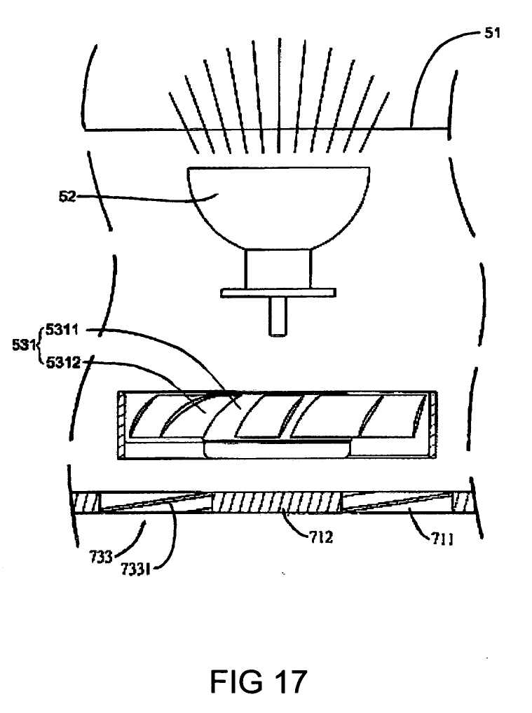

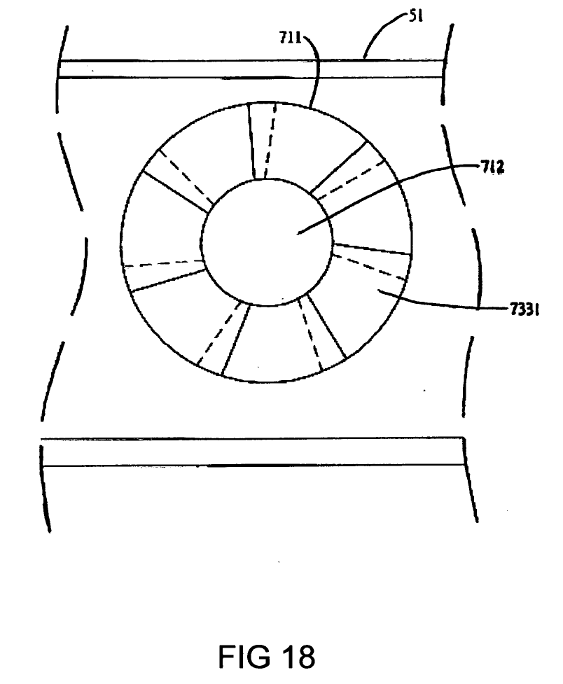

Referring to FIGS. 17 and 18, the sixth embodiment of the present invention is illustrated. The entire structure and function of the second embodiment are almost the same as the preceding embodiment and it is noted that identical parts are designated as the same reference numbers. The difference of the present embodiment is in that the window hole 711 is circular with a central member 712 therein. The light shading unit 733 provides a plurality of support plates 7331 spacing apart each other and overlapping to another one of the support plates 7331 next to it. Further, the support plates 7331 are arranged radially to perform light shading as well.

While the invention has been described with referencing to preferred embodiments thereof, it is to be understood that modifications or variations may be easily made without departing from the spirit of this invention, which is defined by the appended claims.

What is claimed is:

1. A heat radiation device capable of blocking light leakage, which is applied to a projection system with at least a light source, comprising:
a fan wheel, having a hub and a plurality of fan blades extending outward from the hub radially and each of the fan blades spacing apart each other and overlapping to another one of the fan blades next to it;
a fan frame, having an inner wall thereof defining a flow passage to receive the fan wheel, the radial volume of the flow passage being greater than the diametrical area of the fan wheel and a clearance being kept between the fan wheel and the flow passage; and
a stop part, being provided at a rim of the fan frame and extending toward the center of the fan frame;
whereby, light projecting to the heat dissipation device from the light source is shaded by way of the overlapped fan blades and the stop part at the rim of the fan frame to avoid light leakage.

2. The heat radiation device capable of blocking light leakage as defined in claim 1, wherein an extended distance of the stop part is equal to the clearance between the flow passage and the fan wheel.

3. The heat radiation device capable of blocking light leakage as defined in claim 1, wherein an extended distance of the stop part exceeds the clearance between the flow passage and the fan wheel.

4. A heat radiation device capable of blocking light leakage, which is applied to a projection system with at least a light source, comprising:
a fan wheel, having a hub and a plurality of fan blades extending outward from the hub radially and each of the fan blades spacing apart each other and overlapping to another one of the fan blades next to it; and
a fan frame, having the inner wall being slant to define a conical flow passage for receiving the fan wheel, the flow passage forming a first end and a second end at two lateral sides of the fan frame with a radial volume of the first end being greater than the diametrical area of the fan wheel and a radial volume of the second end being not greater than the diametrical area of the fan wheel.
whereby, light projecting to the heat dissipation device from the light source is shaded to avoid light leakage.
The heat radiation module with a transverse flow fan as defined in claim 1, wherein the cooling fins are mounted to a base protruding from the central area of the radiator.

5. The heat radiation device capable of blocking light leakage as defined in claim 4, wherein the flow passage receives a hub seat for being attached with the fan frame.

6. The heat radiation device capable of blocking light leakage as defined in claim 4, wherein a plurality of support members are provided between the hub seat and the inner wall of the fan frame,

7. The heat radiation device capable of blocking light leakage as defined in claim 6, wherein the support members are arranged to space apart from each other.

8. The heat radiation device capable of blocking light leakage as defined in claim 6, wherein each of the support members overlaps another one of the support members next to it respectively.

9. A heat radiation device capable of blocking light leakage, which is applied to a projection system with at least a light source, comprising:
a fan wheel, having a hub and a plurality of fan blades extending outward from the hub radially and each of the fan blades spacing apart each other and overlapping to another one of the fan blades next to it;
a fan frame, having the inner wall thereof defining a flow passage to receive the fan wheel, the radial volume of the flow passage being greater than the diametrical area of the fan wheel and a clearance being kept between the fan wheel and the flow passage; and
a shading unit, being provided between the hub seat and the fan frame;
whereby, light projecting to the heat dissipation device from the light source is shaded by way of the shading unit to avoid light leakage.

10. The heat radiation device capable of blocking light leakage as defined in claim 9, wherein the light shading unit is provided with a plurality of support members.

11. The heat radiation device capable of blocking light leakage as defined in claim 9, wherein the light shading unit is provided with at least a support member and a plurality of concentric rings connecting with the support member and the concentric rings are slant with each of the concentric rings spacing apart to each other and overlapping to another one of the concentric rings next to it respectively.

12. The heat radiation device capable of blocking light leakage as defined in claim 10, wherein a plurality of support members are provided with each of the support members spacing apart to each other and overlapping to another one of the support members next to it respectively.

13. A projection system capable of blocking light leakage, comprising
a casing, being provided with at least a window hole;
a light source, being disposed in the casing;
a heat dissipation device, being disposed between the light source and the window hole, providing a fan wheel with a plurality of fan blades extending outward radially; and
a light shading unit, being disposed in the window hole to shade light projecting to the heat dissipation device from the light source for avoiding light leakage.

14. The projection system capable of blocking light leakage as defined in claim 13, wherein the shading unit is provided with a plurality of support plates.

15. The projection system capable of blocking light leakage as defined in claim 13, wherein the light shading unit is provided with at least a support stick and a plurality of concentric rings connecting with the support stick and the concentric rings are slant with each of the concentric rings spacing apart to each other and overlapping to another one of the concentric rings next to it respectively.

16. The projection system capable of blocking light leakage as defined in claim 13, wherein each of the support plates overlaps another one of the support plates next to it respectively.

17. The projection system capable of blocking light leakage as defined in claim 16, wherein the support plates are arranged in parallel.

18. The projection system capable of blocking light leakage as defined in claim 16, wherein the support plates are arranged radially.
